(19) United States
(12) Patent Application Publication
(10) Pub. No.: US 2009/0144904 A1
(43) Pub. Date: Jun. 11, 2009

(54) Inflatable hospital bed and method of using same

(76) Inventor: David Moye, Raleigh, NC (US)

Correspondence Address: TRIANGLE PATENTS, P.L.L.C., P.O. BOX 28539, RALEIGH, NC, 27611-8539, US

(21) Appl. No.: 12/001,183

(22) Filed: Dec. 10, 2007

(51) Int. Cl. A61G 7/00

(52) U.S. Cl. 5/620; 5/600

(57) ABSTRACT

An auxiliary, inflatable hospital bed with a unitary, integral bed body having an outer surface for supporting a patient and a cavity within the outer surface that is capable of being filled with a fluid. In the filled state, it provides a support structure for the patient that includes contours for retaining the patient on the top surface of the bed body; in an empty or collapsed state, it is compact and relatively flat, providing for easy storage and transport.

### BACKGROUND OF THE INVENTION

1. Field of the Invention

The present invention relates generally to industrial-grade bed products, and more particularly, to inflatable hospital beds for use in hospitals and/or medical care facilities to manage patient overload in the event of mass casualty or catastrophic situation

2. Description of the Prior Art

In medical facilities around the world, there is a growing need for auxiliary bedding for patients. Current auxiliary hospital bedding is limited by the storage capacity of any given facility. Additionally, this auxiliary bedding is limited in form and function thus providing a less comfortable option for the patient. Many hospitals would be severely under equipped to manage the influx of patients should there be a mass incident or pandemic outbreak. A compactly storable yet fully functional and portable form of hospital bedding is needed to alleviate the stress and unmanageability of such an increase in patients. By providing a collapsible and inflatable bed that is easily stored and transported to the site of an incident or easily set up within a hospital location wherever additional institutional-grade beds are required, the medical team is provided with the best opportunity for emergency patient care. None of the prior art is known to provide all of these features and benefits with the embodiment of a unitary, integral construction that is robust and durable, easily cleanable and re-usable under these conditions.

Some examples of prior art include:

U.S. Pat. No. 6,886,204 and US Publication No. 20050278861—Multiple position air mattress System; this invention describes multiple position air mattress system for achieving various support positions. Incorporated bellows unit can be inflated to provide custom elevation of the head while in the prone position

U.S. Pat. No. 5,815,862—Portable Orthopedic Bed; this invention provides an inexpensive, highly adjustable bedding option for homebound patients, including an inflatable bed providing custom orthopedic support. Combines multiple independently filled air chambers to provide custom support to the head, neck upper and lower back, lumbar, thighs and lower legs. It appears to be compact, lightweight, able to be transported in a suitcase

U.S. Pat. No. 7,134,158 & US Publication No. 20060021146—Portable, adjustable, inflatable bed; this document describes a bed apparatus with two inflatable members capable of elevating the head and legs, including spacing and inflation capabilities allowing for adjustable bed height and length to meet the physical demands of a wide range of users.

U.S. Pat. No. 4,594,743—Air Support Bed; provides a portable and easily stored inflatable bedding system comprised of an air mattress and collapsible tubular support frame.

US Publication No. 20060236464—Multi Multi-compartmented air mattress; this document describes an air mattress structure combining multiple non-interconnecting air chambers for selective inflation providing a custom mattress to address the needs of individual patients. Additionally, the cells can be programmed to vary their inflation to prevent the formation of decubitus ulcers, bed sores, due to prolonged pressure on select areas of the body.

U.S. Pat. No. 4,977,629—Portable inflatable patient assist apparatus; this invention discloses a portable inflatable pad for use in conjunction with a hospital bed. Said pad uses independent inflatable chambers in order to assist the patient in rolling from side to side to improve circulation and prevent bed sore formation. The chambers can also be used to raise the hips in order to accommodate a bedpan.

U.S. Pat. No. 6,775,868—Inflatable mattress system and method of manufacturing mattress thereof; it describes a system and manufacturing method for producing an inflatable air mattress with separately inflated longitudinal side rails and lateral cross support tubes. This system enables the side rails to remain inflated should the mattress itself rupture or lose pressure ensuring that a patient will not roll or drop to an uncomfortable surface below the mattress.

U.S. Pat. No. 5,623,736—Modular inflatable/air fluidized bed; it describes a modular inflatable air bed designed for both hospital and home use. This invention involves pilot operated check valves which serve to maintain system pressure should the power supply be interrupted. This would prevent the bed from slumping and allowing the patient to make contact with the hard surface beneath the bed.

Thus, in light of the prior art known, there remains a need for an inflatable hospital bed for use in catastrophic or medical situations wherein the existing hospital bed capacity is exceeded, the beds having certain functionality and/or components that prevent a patient from rolling off of the bed, allow adjustment of various parts of the bed that support the patient's body, and/or modulate pressure under a patient's body to prevent bed sores/ulcers, all being provided in a unitary, integral construction that is inflatable or expandable and collapsible for storage.

### SUMMARY OF THE INVENTION

A first aspect of the present invention is to provide an auxiliary, inflatable hospital bed with a unitary, integral bed body having an outer surface for supporting a patient and a cavity within the outer surface that is capable of being filled with a fluid. In the filled state, it provides a support structure for the patient that includes contours for retaining the patient on the top surface of the bed body; in an empty or collapsed state, it is compact and relatively flat, providing for easy storage and transport.

A second aspect of the present invention is to provide a method of using the bed set forth herein, including providing it in a collapsed, compact state for storage and transport, and inflating or filling its cavity to provide an activated state for supporting and retaining a patient thereon.

Thus, the present invention provides for auxiliary hospital bed capacity with a portable, compact bed that is storable in a collapsed or empty state and usable for supporting and retaining a patient in an activated or filled state. Following use, the bed is cleanable and re-collapsible for storage and re-use upon refilling with the fluid when needed.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a perspective view of the inflatable hospital bed according to one embodiment of the present invention, shown in a filled state.

FIG. 2 is top cross-sectional view of an alternative embodiment of the present invention.

FIG. 3 is a front cross-sectional view of the invention in accordance with the embodiment of the present invention shown in FIG. 2.

FIG. 4 is a side cross-sectional view of the invention in accordance with the embodiment of the present invention shown in FIG. 2.

FIG. 5 is a front cross-sectional view of an alternative embodiment of the present invention.

FIG. 6 is a front cross-sectional view of an alternative embodiment of the present invention.

FIG. 7 is a side cross-sectional view of the invention in accordance with the embodiment of the present invention shown in FIG. 6.

FIG. 8 is another side cross-sectional view of the invention in accordance with the embodiment of the present invention shown in FIG. 6, shown at a different cross-sectional plane than FIG. 7.

FIG. 9 is a front cross-sectional view of an alternative embodiment of the present invention.

FIG. 10 is a side cross-sectional view of the invention in accordance with the embodiment of the present invention shown in FIG. 9.

FIG. 11 is a packaged view of an embodiment of the present invention in a collapsed state.

FIG. 12 is a side view of another embodiment of the present invention, illustrating an alternative embodiment of the inclinable support structure.

FIG. 13 is a side view of the invention in accordance with the embodiment of the present invention shown in FIG. 12.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides an auxiliary, inflatable hospital bed with a unitary, integral bed body having an outer surface for supporting a patient and a cavity within the outer surface that is capable of being filled with a fluid. In the filled state, it provides a support structure for the patient that includes contours for retaining the patient on the top surface of the bed body; in an empty or collapsed state, it is compact and relatively flat, providing for easy storage and transport. A method of use of the bed according to the present invention is also provided.

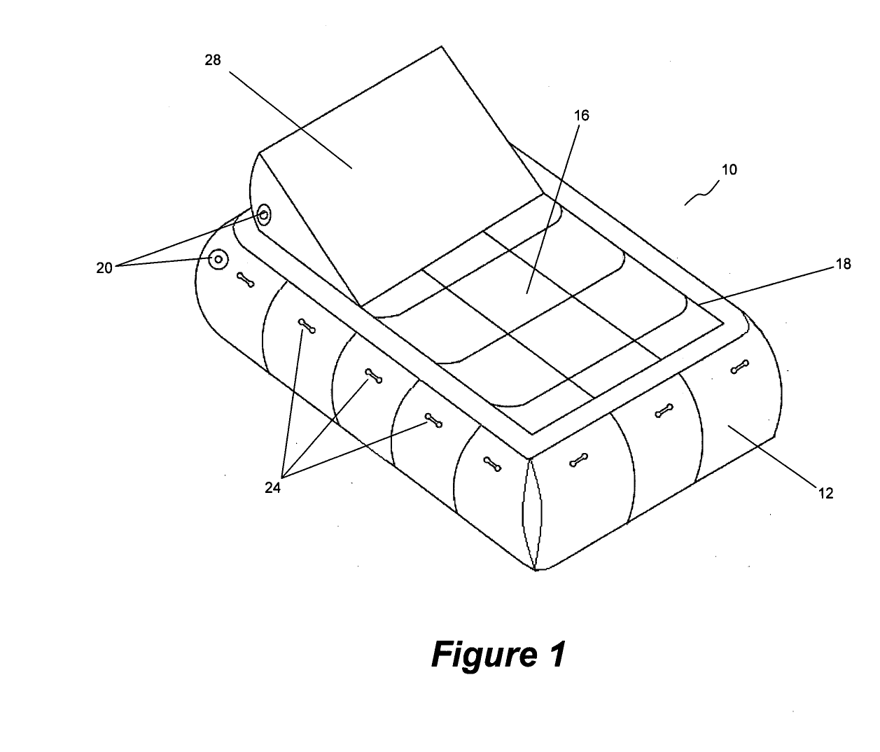

Referring now to the drawings in general, the illustrations are for the purpose of describing a preferred embodiment of the invention and are not intended to limit the invention thereto. FIG. 1 is a perspective view of the inflatable hospital bed according to one embodiment of the present invention, shown in a filled state.

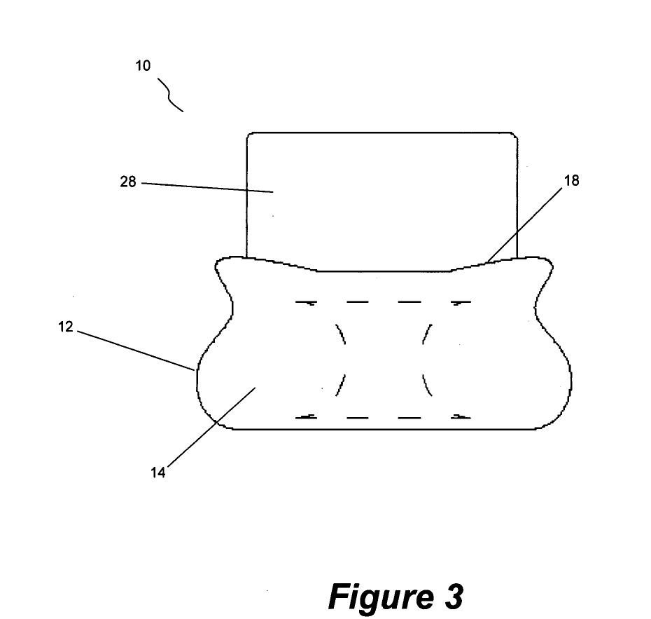

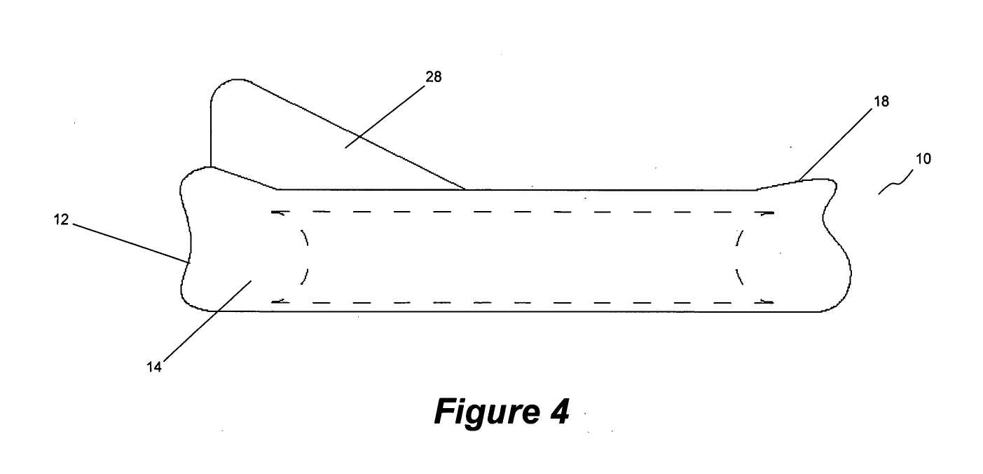

The present invention provides an inflatable hospital bed for supporting a patient, the bed including a unitary, integral bed body 10 having an outer surface 12 for supporting a patient and a cavity 14 within the outer surface (seen in other Figures, e.g. FIGS. 3 and 4); wherein the cavity is capable of being filled with a fluid (not shown) for providing a support structure 16 for the patient, the support structure including contours 18 for retaining the patient on the top surface of the bed body when the cavity is filled between a first and a second volume of fluid. Preferably, the cavity first volume is greater than about 20% of the completely filled volume and the second volume is between about 80% to about 100% of the completely filled volume. Optionally, the bed body cavity fluid volume is adjustable between the first and second positions while the patient is supported and retained on the surface of the bed.

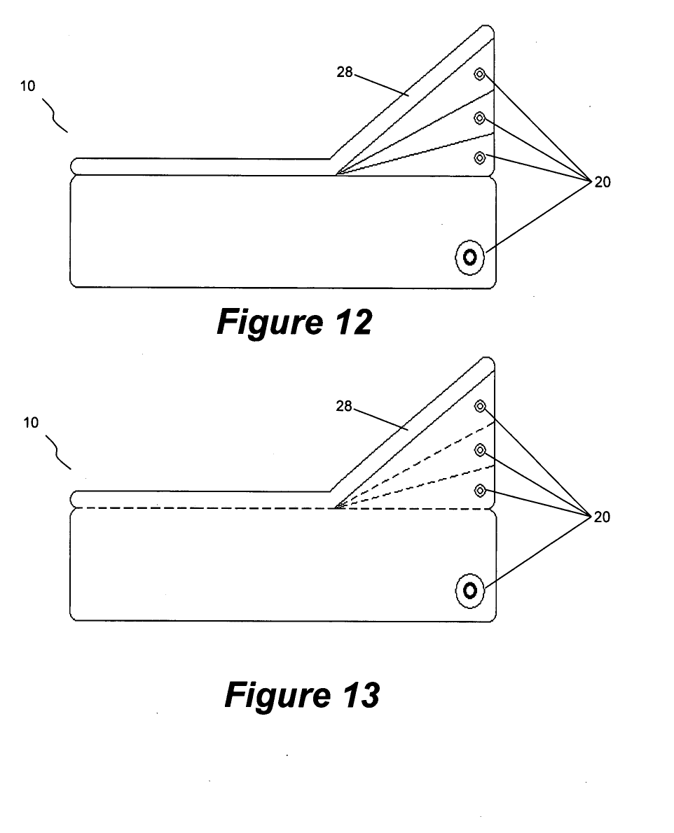

In a preferred embodiment of the present invention, the bed further includes at least one fluid portal 20 in the bed body operable for the introduction of the fluid into the bed body cavity. This at least one portal has a corresponding seal operable between an open and a closed position, and a valve (not shown) that is functional to control the flow of fluid into and/or out of the bed body cavity. Flexible baffled zones provide for internal volume modification. For instance, the present invention preferably also includes an inclinable support structure 28 for supporting a patient's torso, back, and/or head. The inclinable support structure may be adjusted by adding or removing fluid via its fluid portal. Alternatively, as seen in FIGS. 12 and 13, the inclinable support structure 28 may have multiple fluid portals 20 each connected to a compartmentalized section of the inclinable support structure; these contained sections may be individually inflated or deflated to adjust the inclinable support structure.

Following use, the bed is cleanable and re-collapsible for storage and re-use upon refilling with the fluid when needed.

In preferred embodiments of the present invention, the bed body further includes attachment points 24 for bedding or appurtenances, such as adapters for receiving electrical outlets, diagnostic components, such as sensors for monitoring cavity volume and/or patient-related information. Attachment points for bedding provide for the releasable attachment of the bedding for easy attachment and removal without adjusting the bed cavity volume or requiring the bed body to be moved or shifted.

To provide the flexibility to exist robustly in an active, filled (inflated) state and to alternatively exist in an inactive, empty (collapsed) state for storage when not in use, the unitary, integral bed body is preferably formed from a flexible material, such as by way of example and not limitation, a synthetic material. The material requirements provide for flexibility and relatively closed surfaces to prevent fluid escape when the cavity is filled, to withstand the pressure when the cavity is filled and when a patient's body weight is placed thereon.

The bed body surface is preferably designed and constructed in a unitary, integral manner, i.e., without seams or joints, which facilitates cleaning externally. Additionally and optionally, the outer surface includes an antimicrobial treatment or coating, a sealant, a colorization, or other functional application.

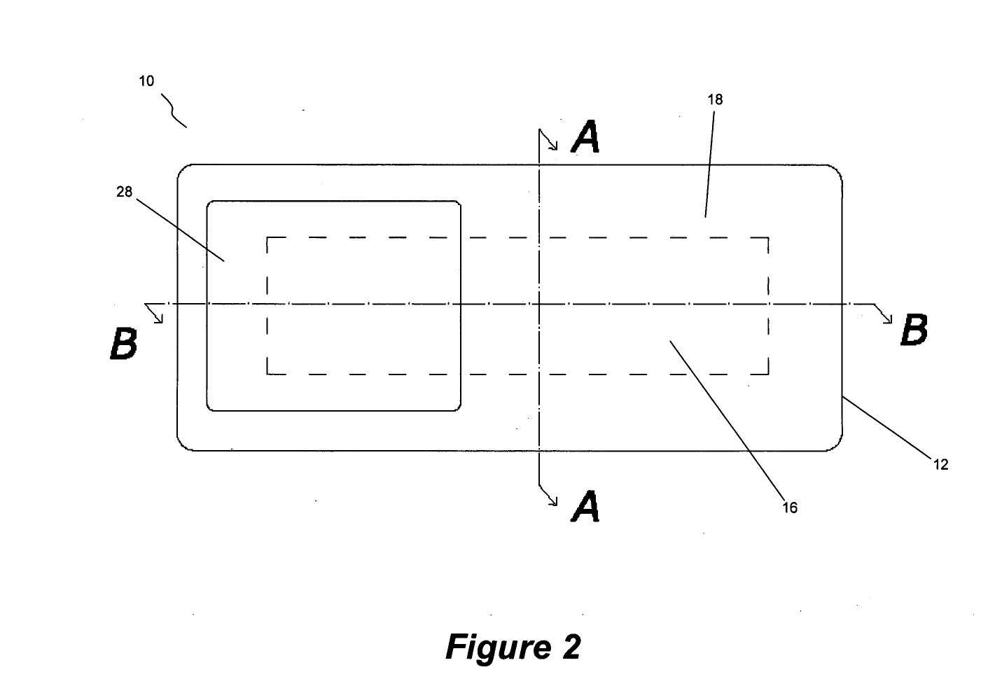

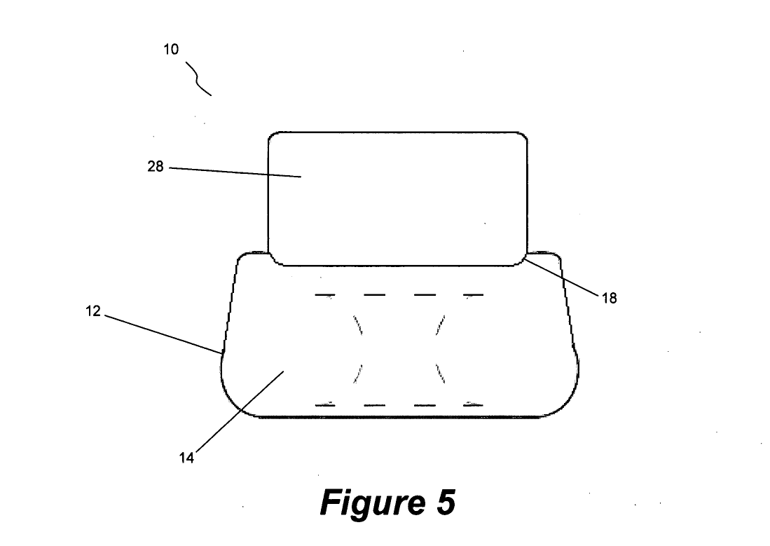

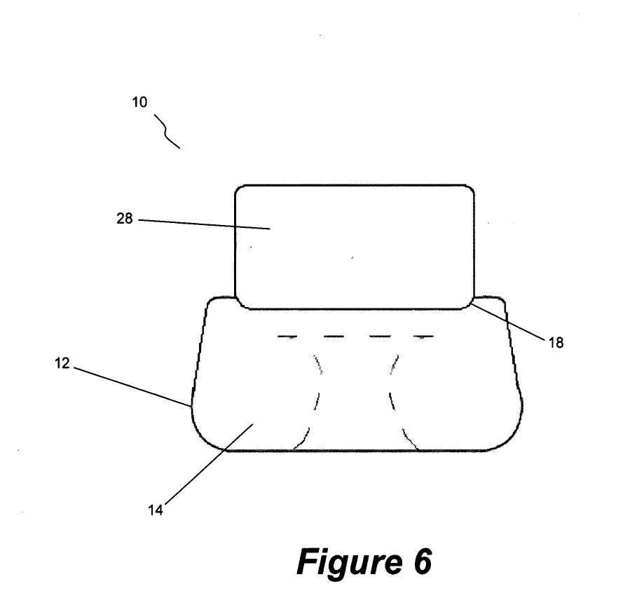

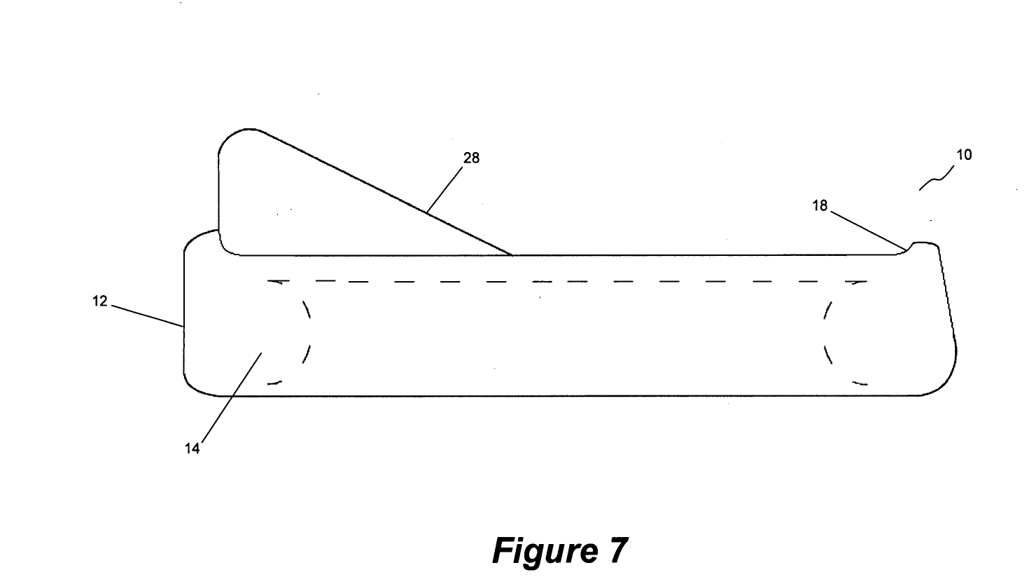

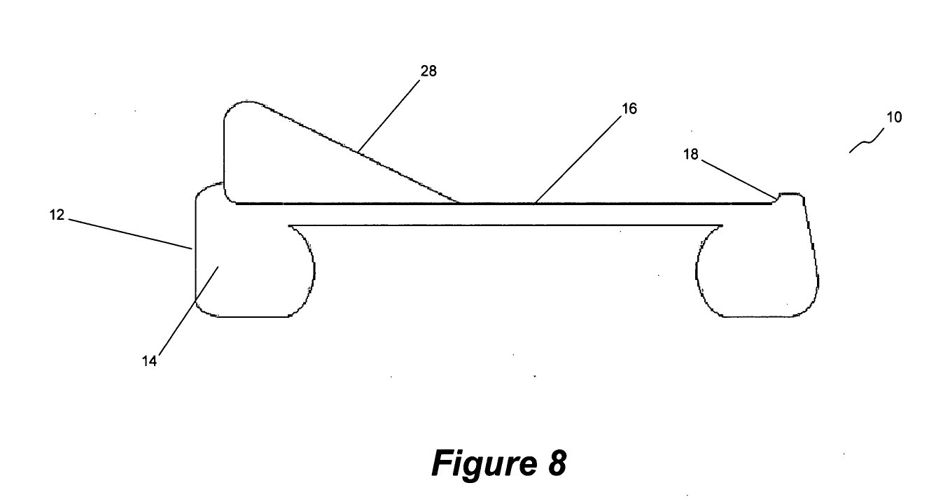

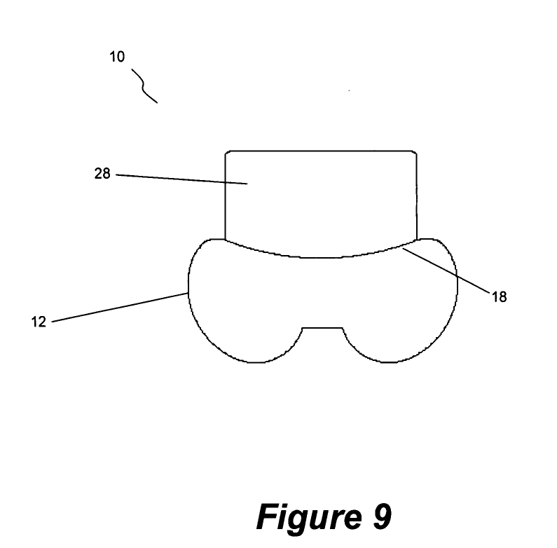

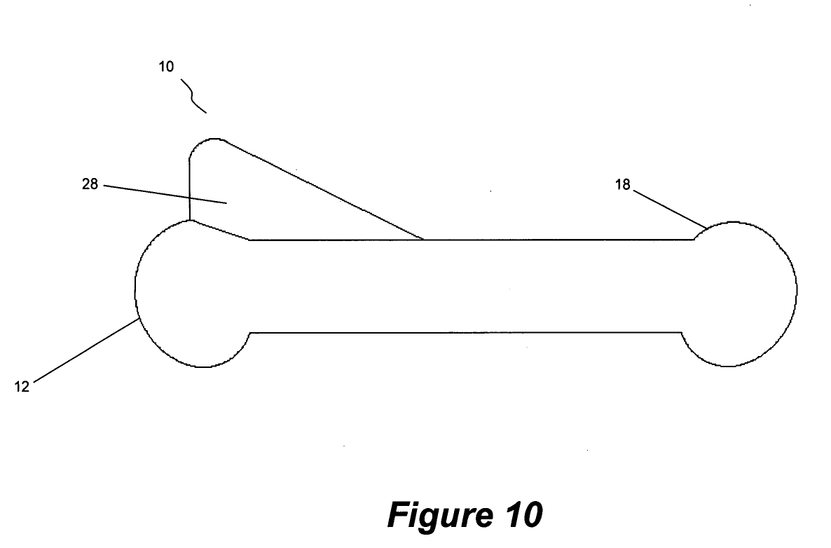

Multiple embodiments of the present invention are possible incorporating various integral bed body shapes and designs. Examples include, but are not limited to, FIG. 1, FIGS. 2-4, FIG. 5, FIGS. 6-8, and FIGS. 9-10 which illustrate at least four possible embodiments provided for by the present invention, respectively. Among other differences, these different embodiments vary the shape and style of contours 18 for retaining the patient on the top surface of the bed body when the cavity is filled between a first and a second volume of fluid.

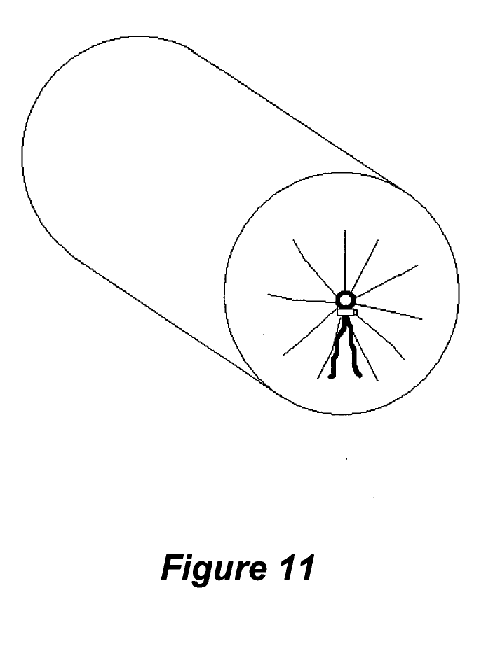

The present invention also provides a method of using the bed described hereinabove, including providing it in a first collapsed, compact state for storage and transport, see FIG. 11 for an example of a packaged view of an embodiment of the present invention in a collapsed, rolled state, and inflating or filling its cavity with fluid to provide a second or activated state for supporting and retaining a patient thereon. These two states may also be referred to as empty and filled, respectively.

The method of using an inflatable hospital bed for supporting a patient includes the steps of: providing a unitary, integral bed body having an outer surface for supporting a patient and a cavity within the outer surface; wherein the cavity is capable of being filled with a fluid for providing a support structure for the patient, the support structure including contours for retaining the patient on the top surface of the bed body; and filling the cavity volume with fluid such that the bed body is operable to support and retain the patient on a top side of the outer surface.

The step of filling the cavity volume with fluid includes introducing the fluid by an external force, such as, by way of example and not limitation, pumping, pressurized introduction, and the like. However, other internal options are possible, such as by way of example and not limitation explosive air or fluid release (as with air bag functionality in a vehicle); in this case, the fluid introduction is internal to the cavity within the bed body, which provides that the body may be completely integral and unitary without a fluid introduction portal. Preferably, the fluid is externally introduced through at least one fluid portal; more than one portal provides for more rapid fluid introduction.

During use, an additional step of adjusting the fluid volume is optionally included.

Following use, additional steps are included in the method:

cleaning the bed surface; collapsing the bed body for storage by evacuating, exhausting or otherwise eliminating or releasing the fluid from the cavity; storing the bed body in the collapsed or empty state; and refilling the cavity within the bed body with fluid as needed for re-use. These steps are repeatable separately and in selective combination.

Certain modifications and improvements will occur to those skilled in the art upon a reading of the foregoing description. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

1. An inflatable hospital bed for supporting a patient the bed comprising:
a seamless unitary, integral bed body having an outer surface for supporting a patient;
and a single cavity within the outer surface;
wherein the cavity is capable of being filled with a fluid for providing a support structure for the patient
the support structure including contours for retaining the patient on the top surface of the bed body;
wherein the cavity provides the support for the patient when the cavity is filled between a first and a second volume of fluid.

2. The bed of claim 1, wherein the bed further includes at least one fluid portal in the bed body operable for the introduction of the fluid into the bed body cavity.

3. The bed of claim 2, wherein the at least one portal has a corresponding seal operable between an open and a closed position.

4. The bed of claim 3, wherein the seal further includes a valve that is functional to control the flow of fluid into and/or out of the bed body cavity.

5. The bed of claim 1, wherein the cavity first volume is greater than about 20% of the completely filled volume.

6. The bed of claim 1, wherein the second volume is between about 80% to about 100% of the completely filled volume.

7. The bed of claim 1, wherein the bed body further includes attachment points for appurtenances.

8. The bed of claim 1, wherein the bed body further includes adapters for receiving electrical outlets.

9. The bed of claim 1, wherein the bed body further includes diagnostic components.

10. The bed of claim 9, wherein the diagnostic components include sensors for monitoring cavity volume.

11. The bed of claim 1, wherein the unitary, integral bed body comprises a flexible material.

12. The bed of claim 1, wherein the material is synthetic.

13. A method of using an inflatable hospital bed for supporting a patient comprising the steps of:
providing a seamless unitary, integral bed body having an outer surface for supporting a patient and a single cavity within the outer surface; wherein the cavity is capable of being filled with a fluid for providing a support structure for the patient, the support structure including contours for retaining the patient on the top surface of the bed body; and
filling the cavity volume with fluid such that the bed body is operable to support and retain the patient on a top side of the outer surface.

14. The method of claim 13, wherein the step of filling the cavity volume further includes externally introducing the fluid through at least one fluid portal in the bed body.

15. The method of claim 13, further including the step of cleaning the bed surface.

16. The method of claim 13, further including the step of collapsing the bed body for storage by evacuating the fluid from the cavity.

17. The method of claim 16, further including the step of storing the bed body in the collapsed or empty state.

18. The method of claim 17, further including the step of refilling the cavity within the bed body with fluid as needed for re-use.
